(19) United States
(12) Patent Application Publication
(10) Pub. No.: US 2009/0040763 A1
(43) Pub. Date: Feb. 12, 2009

(54) Light Source

(75) Inventors: Kelly Stockwell, Putney, VT (US); Edward Kiegle, Chester, VT (US)

Correspondence Address: OCCHIUTI ROHLICEK & TSAO, LLP, 10 FAWCETT STREET, CAMBRIDGE, MA, 02138, US

(73) Assignee: Chroma Technology Corporation, Rockingham, VT (US)

(21) Appl. No.: 12/052,190

(22) Filed: Mar. 20, 2008

Related U.S. Application Data
(60) Provisional application No. 60/919,348, filed on Mar. 20, 2007.

(51) Int. Cl. F21V 9/04; F21V 9/06

(52) U.S. Cl. 362/293

(57) ABSTRACT

A light source for fluorescence microscopy is designed to provide relatively constant illumination (lumens) of the specimen over the useful life of the light generator, such as the bulb, arc, or filament. In another aspect, the present invention provides for a light source for fluorescence microscopy designed to reduce heat transmission to optical components from the light generator, while providing adequate transmission of the required excitation wavelengths of light.

This invention claims the benefit of U.S. Provisional Application Ser. No. 60/919,348, filed on Mar. 20, 2007, and entitled “Light Source.” The contents of this application are hereby incorporated by reference in its entirety.

### BACKGROUND

This invention relates to a light source for use in fluorescence microscopy.

Fluorescence microscopy is the study of the microscopic properties of organic or inorganic substances using the phenomena of fluorescence and phosphorescence instead of, or in addition to, reflection and absorption. In most cases, a component of interest in the substance is specifically labeled with a fluorescent molecule called a fluorophore (such as Texas Red, FURA, and green fluorescent protein, among many others). The specimen is illuminated with light of a specific wavelength (or wavelengths), typically referred to as the excitation wavelength, which is absorbed by the fluorophore. The excitation wavelength specific to a particular fluorophore causes the fluorophore to emit light (fluoresce) at a wavelength different than the excitation wavelength.

Typical wide field fluorescence microscopes include a light source that provides a wide spectrum of high intensity light across the relevant wavelengths from the ultraviolet and extending through the visible range into the infrared. A typical light source includes a lamp such as a Xenon or Mercury arc-discharge lamp. The spectral range of the light source can be controlled with an excitation filter, a dichroic mirror (or dichromatic beamsplitter), and an emission filter. The filters and the dichroic mirror are chosen to match the spectral excitation and emission characteristics of the fluorophore used to label the specimen. The apparatus may also include other filters, such as blockers, polarizers, bandpass filters, and neutral density filters, depending on the particular application. Applications of fluorescence microscopy as well as the range and type of available fluorophores are rapidly emerging and constantly changing, requiring designers of microscopes, filters, and other apparatus, including light sources, used in the fluorescence microscopy field to keep pace. See, e.g., Handbook of Optical Filters for Fluorescence Microscopy, HB 1.1., June 2000, available at www.chroma.com. Applications of fluorescence microscopy demand increasingly higher levels of input illumination to image the specimen. Such higher levels of illumination require light sources with higher power output, with corresponding increases in heat and light generated by such light sources. Light sources for fluorescent microscopy may conveniently be provided in a separate apparatus from the microscope, specimen, and application-specific optical filters. Light sources may also be provided at some distance from the microscope and the specimen by a light guide connecting the light source and the microscope. Light sources may also include fans, baffles and flow adjusters to control the temperature of the heat-sensitive elements of the light source, such as the lamp and the light guide.

Optical apparatus may include a hot mirror, which is a specialized dielectric mirror or dichromatic interference filter often employed to protect optical systems by reflecting heat back into the light source. Hot mirrors can be designed to be inserted into the optical system at an incidence angle varying from zero to 45 degrees, and are useful in a variety of applications where heat build-up can damage components or adversely affect spectral characteristics of the light source. Wavelengths reflected by a typical infrared hot mirror range from about 750 nm to 1250 nm. By transmitting excitation wavelengths in the visible spectrum and below, while reflecting infrared wavelengths, hot mirrors can also serve as dichromatic beam splitters for specialized applications in fluorescence microscopy.

### SUMMARY

In one aspect of the present invention, a light source for use with a fluorescent microscope includes a high intensity lamp, an optical output and a mirror positioned between the lamp and optical output. The high intensity lamp provides better light output than existing metal halide light sources and the same light output in the ultraviolet range as existing mercury lamps.

The mirror is configured to receive light from the lamp and allow substantial transmission of the light at a wavelength in a range between 320 nanometers and 680 nanometers (nm) to the optical output while preventing transmission of the light to the optical output at wavelengths less than 320 nanometers and greater than 680 nanometers.

In another aspect of the invention, a light source includes a lamp, a power source for the lamp, an optical output; and a controller configured to vary the amount of power supplied to the lamp as a function of the operational use of the lamp.

Embodiments of these aspects may include one or more of the following features. The mirror is further configured to prevent transmission of the light to the optical output at wavelengths above about 800 nanometers while allowing greater than 85% transmission at 340 nanometers and more than 90% transmission in the range of 320 to 680 nm. The mirror includes multi-layer dielectric coatings preferably manufactured by a sputtering process on a Pyrex substrate. The mirror is positioned at an incidence angle in a range of 0 degrees to about 45 degrees (e.g., 10 degrees). The light source includes an angle mounting bracket for positioning the mirror at the incidence angle. The mirror is positioned intermediate the lamp and liquid light guide. The mirror is configured to reflect heat energy produced or generated by the lamp.

The light source can further include one or more flow adjusters, neutral density filters or screens, shutters, and heat sinks disposed between the lamp and the optical output.

Among other advantages, a light source for fluorescence microscopy provides high intensity and relatively constant illumination (lumens) of the specimen over the useful life of the light generator, such as the bulb, arc, or filament. The light source is configured to reduce heat transmission to optical components from the light generator, while providing high intensity light output and transmission of the required excitation wavelengths of light.

### DESCRIPTION OF DRAWINGS

FIG. 1 is a block diagram representation of a light source for a microscope.

FIG. 2 shows the light source of FIG. 1.

FIG. 3 is a block diagram representation of another embodiment of a light source for a microscope.

FIG. 4 shows a portion of the light source of FIG. 3.

FIG. 5 shows the transmission characteristic of a hot mirror used with the light source of FIG. 3.

### DESCRIPTION

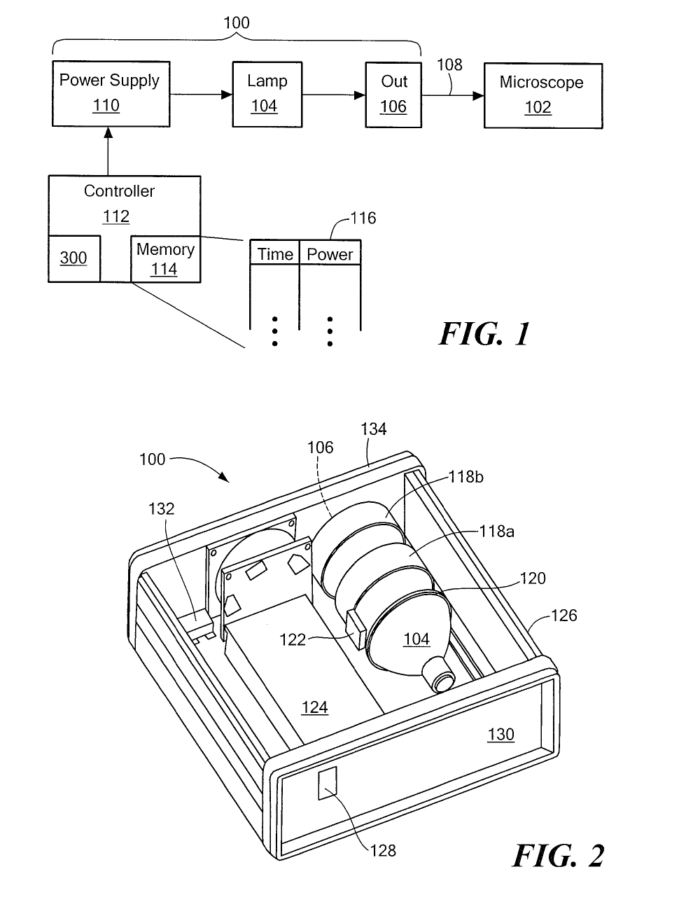

Referring to FIG. 1, a light source 100 provides light to a fluorescent microscope 102. Light source 100 includes a 200 watt lamp 104, such as, for example, a Model SMR-200/D1 available from USHIO AMERICA, INC., Cypress, Calif. Lamp 104 may be a metal halide lamp. Lamp 104 provides illumination to an optical output interface 106 which is connected to microscope 102 via a liquid light guide 108 (e.g., a 1 meter long light guide having a 5 mm core diameter, available from Lumatec, Deisenhofen, Germany). Light source 100 also includes a power supply 110 that provides power to the lamp.

In one embodiment, the power level provided by power supply 110 is regulated so that as the characteristics of lamp 104 change over time, the power level changes such that the amount of light (measured in lumens) provided to the optical output interface 106 is substantially constant. For example, the amount of light emitted from lamp 104 may steadily decrease over time. Because the decrease in lamp intensity is relatively repeatable from one lamp to another lamp of the same model, lamps of a particular model can be tested to characterize their degradation as a function of time. To maintain the same amount of light from lamp 104, the power provided to the lamp is increased over time. Thus, the level of light intensity from lamp 104 is relatively constant over the operational life of the lamp. Furthermore, the operational useful life of the lamp is extended. The increase in the amount of power provided to lamp 104 by power supply 110 is regulated by using a controller 112. Controller 112 includes a memory 114 that tracks an amount of time lamp 104 has been operational. Memory 114 also stores data that associates the amount of time that lamp 104 has been operational with a power level. For example, in one embodiment the power level would increase about 2 watts for every time interval corresponding to the decrease in lamp output over the same time interval based upon empirically collected data of lamp degradation over time. In one embodiment, the data is stored in a table 116 having a series of time durations and corresponding power levels. The values in table 116 are generated through the empirically collected data for each model of lamp 104. In other embodiments, the level of light intensity from lamp 104 is not adjusted.

Controller 112 is provided with a user interface 300 that can operate in multiple modes. User interface 300 includes a display, such as a liquid crystal display, to display menu screens and messages about the status of operational parameters. User interface 300 also includes switches that a user can press to switch between modes of operation or to enter or change operating parameters. In one mode of operation, user interface 300 displays the operational status of light source 100, such as the amount of time lamp 104 has been operational. In another mode, the user can alter operational settings of the user interface. For example, the user may change the volume of an audible alarm, or the contrast or backlight level of the display. In another mode, user interface 300 operates in a diagnostic mode.

Referring to FIG. 2, light source 100 shows lamp 104 optically coupled to output interface 106 through a pair of flow adjusters 118a, 118b. Each flow adjuster 118a, 118b has a lamp mount 120 at its downstream end. Flow adjusters 118a, 118b are configured and positioned to maintain the temperature across the anode and cathode of the lamp within specified operating ranges. The flow adjuster 118a positioned closest to lamp 104 includes a fan 122 for controlling the temperature of lamp 104. Light source 100 also includes a ballast 124 that serves as a regulator. Ballast 124 consumes, transforms, and controls electrical power for lamp 104 and provides the necessary circuit conditions for starting and operating lamp 104. Light source 100 further includes lamp thermal sensors and ballast thermal sensors (not shown) that monitor the temperature of lamp 104 and ballast 124, respectively, and lamp interlocks that protect lamp 104. Light source 100 is mounted within a housing 126 having an on/off switch 128 on a front panel 130 of the housing and an AC receptacle 132 on a rear panel 134 of the housing. Light source 100 also has a battery (not shown) that provides power for the light source to run in a low power mode when AC power is not provided (e.g. when the light source is turned off). The battery may be a lithium-ion battery.

Light source 100 includes a lamp sensor to detect when lamp 104 has been disconnected from power supply 110. The lamp sensor is configured to continuously monitor the presence of lamp 104, both when light source 100 is turned on and when it is turned off. When the lamp sensor detects that lamp 104 has been disconnected, a lamp change status is set in memory 114. The lamp change status remains set even if a new lamp 104 is subsequently connected. When light source 100 is next turned on, a message is displayed on the display of user interface 300 asking a user to confirm that a new lamp 104 has been connected. If the user confirms, controller 112 resets the lamp change status and the amount of time that lamp 104 has been operational in memory 114. If the user does not respond within a specified amount of time, for example within two minutes, controller 112 may assume that a new lamp 104 has been connected and take action as if the user had confirmed. If the user responds that the lamp is not a new lamp, the amount of time that lamp 104 has been operational is not reset and the lamp change status is reset in memory 114.

User interface 300 displays warning or error messages on the display in the event of a warning or error condition, respectively. Warning or error conditions are detected while light source 100 is in operation. Controller 112 also performs diagnostic tests when it is first turned on to check for the presence of warning or error conditions. Warning conditions may include, for example: failure of the lamp interlocks; when the lamp change status is set; when the amount of time that lamp 104 has been operational approaches a first preset limit, for example when the amount of time that the lamp has been operational exceeds 1750 hours; when the amount of light emitted by lamp 104 approaches a second preset limit; when the temperature of lamp 104 exceeds a first preselected lamp temperature, for example when the temperature of the lamp exceeds 90° C.; when the temperature of ballast 124 exceeds a first preselected ballast temperature, for example when the temperature of the ballast exceeds 55° C.; or when housing 126 is open. Error conditions may include, for example: failure of power supply 110; low voltage in the battery; when lamp 104 is disconnected; when ballast 124 is disconnected; when the amount of time that lamp 104 has been operational exceeds the first preset limit, for example when the amount of time that the lamp has been operational exceeds 2000 hours; when the amount of light emitted by lamp 104 exceeds the second preset limit; when the temperature of lamp 104 exceeds a second preselected lamp temperature, for example when the temperature of the lamp exceeds 100° C.; or when the temperature of ballast 124 exceeds a second preselected ballast temperature, for example when the temperature of the ballast exceeds 70° C. When an error condition is detected, lamp 104 and/or ballast 124 may be shut down to protect the lamp from rupture. If any of the lamp thermal sensors, the ballast thermal sensors, or the lamp sensor is defective or disconnected, lamp 104 and/or ballast 124 may be disabled for safety. User interface 300 can be configured to display error or warning messages for other conditions not described herein.

User interface 300 may include an audible alarm. The alarm can be used to indicate, for example, when a switch is pressed, or the existence of warning or error conditions. The alarm may emit sounds that correspond to specific situations. For example, when a switch is pressed, the alarm emits a 100 millisecond beep at a low volume. For a warning, the alarm emits, for example, a warning sequence of 3 beeps of 100 milliseconds at intervals of 200 milliseconds. This warning sequence may be repeated at 30 second intervals. For an error, the alarm emits, for example, an error sequence of 5 beeps of 50 milliseconds at intervals of 50 milliseconds. This error sequence may be repeated at 10 second intervals. The warning and error sequences may be at high volume.

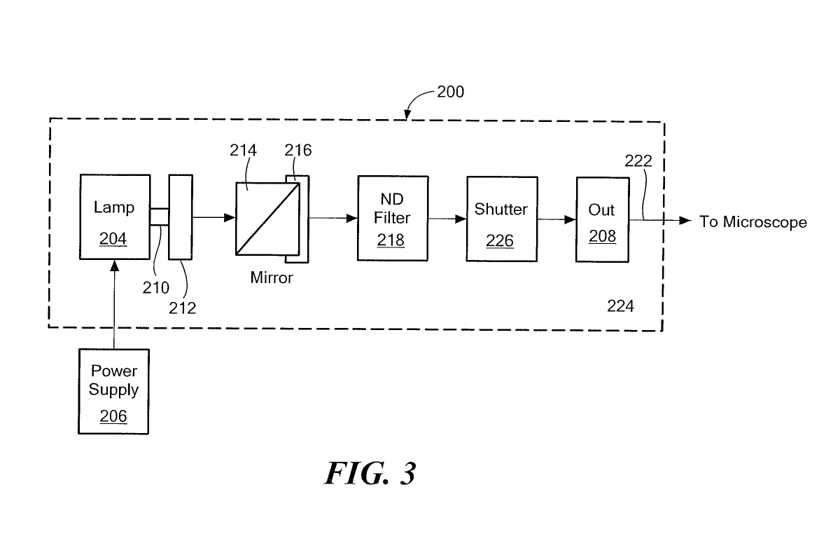

Referring to FIG. 3, in another embodiment, a light source 200 includes a lamp 204 driven by a power supply 206. Lamp 204 provides light to a microscope (not shown) via an output interface 208. In this embodiment, lamp adaptors 210 and flow adjusters 212 are used to control the temperature across the anode and cathode of the lamp within specified operating ranges and are shown installed between lamp 204 and a liquid light guide 222. Lamp 204 may be mounted on a baffle (not shown) in a housing and aligned with a hot mirror 214 having the spectral characteristics described herein and placed in the light path between the lamp and the liquid light guide. Hot mirror 214 is mounted using an angle mounting bracket 216 and secured with heat epoxy at a desired or optimal angle for the specifications of the hot mirror. In one embodiment of the invention, the angle of hot mirror 214 is 10 degrees relative to a plane normal to the lengthwise alignment of the lamp. Hot mirror 214 is designed to reflect a significant portion of the heat energy generated by lamp 204 from the light path to maintain the liquid light guide within its specified range of operating temperatures while still transmitting those wavelengths that are desired or required for the particular application.

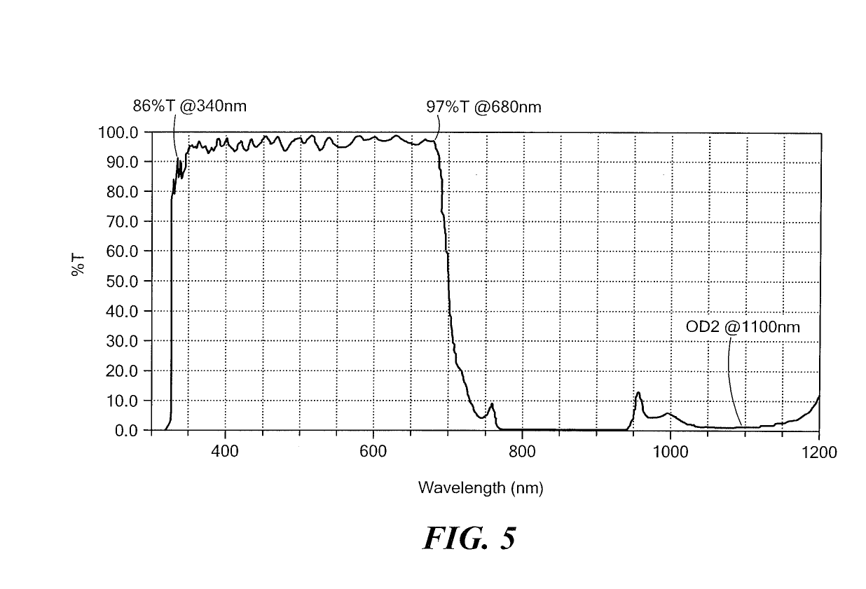

Referring to FIG. 5, in particular, hot mirror 214 transmits in excess of 86% of the light at 340 nm for use with the fluorophore FURA and transmits in excess of 90% of the illumination light in the visible range between 320 nm and 680 nm. At the same time, 90% of more of light is blocked below about 320 nm and above about 680 nm, in the near infrared range and above which are the wavelengths that carry heat. In a preferred embodiment of the invention, the hot mirror is manufactured by a sputtering process on a Pyrex substrate to transmit a minimum of 90% of the illumination light between 365 nm and 577 nm and having the spectral characteristics shown in FIG. 5. The spectral characteristics of hot mirror 214 are shown in FIG. 5 and given by the transmission characteristics (T) below.

T at 365nm >=91%

T at 405nm >=92%

T at 436nm >=93%

T at 546nm >=93%

T at 577nm >=94%

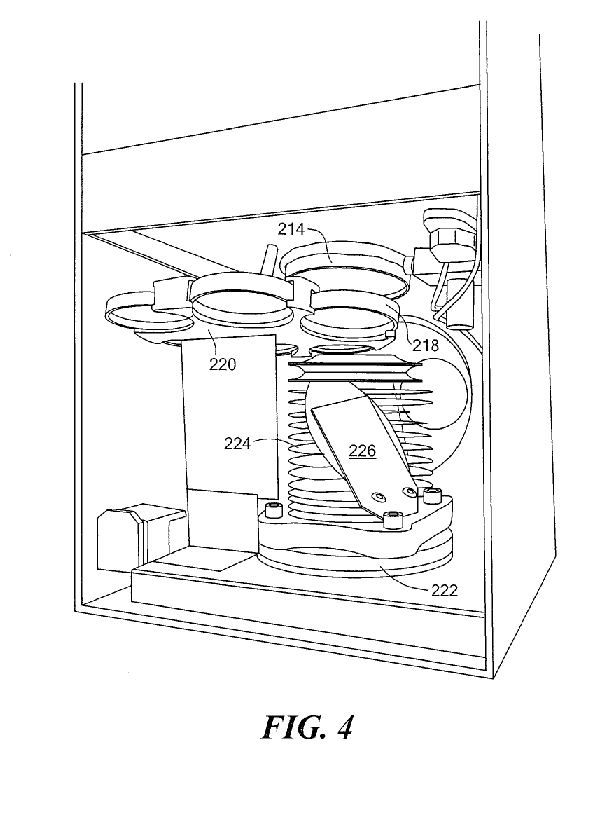

Referring again to FIG. 4, light source 200 can be configured to provide for use of neutral density filters or screens 218 in the light path between the hot mirror and the optical light guides. One or more neutral density filters or screens may be mounted on a movable cartridge or carousel 220 to permit the interchangeable use of neutral density filters or screens of varying degrees of transmission depending on the application. After passing through the hot mirror and the neutral density filter or screen, if any is used, the light is passed to the liquid light guide 222 (FIG. 3) which is attached to the exterior of the housing in alignment with the lamp. A heat sink 224 to dissipate heat from the lamp, including conducted heat, may be provided in physical association with the liquid light guide. A movable shutter 226 to prevent accidental light exposure and/or leakage from the housing when the liquid light guide is removed may also be provided in the path between the lamp and the liquid light guide. In a preferred embodiment, a copper or other metal shutter is mounted adjacent to the attachment point for the liquid light guide at a 45 degree angle.

It is to be understood that the foregoing description is intended to illustrate and not to limit the scope of the invention, which is defined by the scope of the appended claims. Other embodiments are within the scope of the following claims.

1. A light source comprising:
a lamp;
an optical output; and
a mirror positioned between the lamp and the optical output, the mirror configured to receive light from the lamp and to allow substantial transmission of the light at a wavelength in a range between 320 nanometers and 680 nanometers nm to the optical output while preventing transmission of the light to the optical output at wavelengths less than 320 nanometers and greater than 680 nanometers.

2. The light source of claim 1 wherein the mirror is further configured to prevent transmission of the light to the optical output at wavelengths above about 800 nanometers.

3. The light source of claim 1 wherein the mirror is further configured to allow greater than 85% transmission of the light to the optical output at a wavelength of 340 nanometers.

4. The light source of claim 1 wherein the mirror includes multi-layer dielectric coatings.

5. The light source of claim 1 wherein the mirror is positioned at an incidence angle in a range of 0 degrees to about 45 degrees.

6. The light source of claim 5 wherein the mirror is positioned at an incidence angle of about 10 degrees.

7. The light source of claim 1 further comprising an angle mounting bracket for positioning the mirror at the incidence angle.

8. The light source of claim 1 wherein the mirror is positioned intermediate the lamp and the optical output.

9. The light source of claim 1 wherein the mirror is configured to reflect heat energy produced or generated by the lamp.

10. (canceled)

11. The light source of claim 1 further comprising at least one neutral density filter or screen positioned intermediate the mirror and the optical output.

12-23. (canceled)

24. The light source of claim 1, wherein the mirror includes a surface formed by sputtering.
